(19) United States
(12) Patent Application Publication
(10) Pub. No.: US 2005/0269726 A1
(43) Pub. Date: Dec. 8, 2005

(54) Thermal interface material with aligned carbon nanotubes

(76) Inventor: James Christopher Matabayas JR., Chandler, AZ (US)

Correspondence Address: Michael A. Bernadicou;BLAKELY, SOKOLOFF, TAYLOR & ZAFMAN LLP, Seventh Floor, 12400 Wilshire Boulevard, Los Angeles, CA, 90025, US

(21) Appl. No.: 10/887,794

(22) Filed: Jul. 8, 2004

Related U.S. Application Data
(62) Division of application No. 10/670,699, filed on Sep. 24, 2003.

(51) Int. Cl. B29C 47/00

(52) U.S. Cl. 264/104; 427/180; 264/108; 264/437; 264/211; 264/148; 264/171.13

(57) ABSTRACT

Embodiments of the invention provide a thermal interface material. In one embodiment, carbon nanotubes are combined with an alignment material. The alignment material is aligned, which causes the carbon nanotubes to become aligned and efficiently conduct heat.

### BACKGROUND

1. Field of the Invention

This invention relates to cooling of microelectronic systems, and more particularly to use of a nanocomposite thermal interface material that includes aligned carbon nanotubes.

2. Background of the Invention

Microelectronics, such as microprocessors, create heat. Thermal interface materials are used to conduct heat in microelectronics. FIG. 1 is a side view of a microprocessor and heat sink assembly 100 that illustrates how layers of thermal interface materials 104, 108 are used to conduct heat away from the microprocessor die 110 to the heat sink 102. The microprocessor and heat sink assembly 100 includes a substrate 114 to which a microprocessor die 110 is attached. There is a first thermal interface layer (“TIM1”) 108 between the microprocessor die 110 and an integrated heat sink (“IHS”) 106, which is also connected to the substrate 114 by a sealant layer 112. The TIM1 layer 108 is typically a material such as indium solder, with a bulk thermal conductivity of about 80 W/mK.

There is a second thermal interface layer (“TIM2”) 104 between the IHS 106 and a heat sink 102. The TIM2 layer 104 typically currently used is a silicon grease material that has a bulk thermal conductivity of less than 5 W/mK. It is desirable for the TIM2 layer 104 to allow a user to attach the heat sink 102 without special soldering knowledge or equipment, or to be reworkable so that the heat sink 102 may be removed and reattached. This has typically prevented the solder material of the TIM1 layer 108 from also being used as the TIM2 layer 104, even though the thermal conductivities of the solders used in the TIM1 layer 108 are higher than the silicone grease materials used in the TIM2 layer 104.

In operation, the microprocessor die 110 generates heat. The TIM1 layer 108 conducts this heat away from the microprocessor die 110 to the IHS 106. The TIM2 layer 104 then conducts the heat away from the IHS 106 to the heat sink 102, which transfers the heat to the surrounding environment and away from the microprocessor and heat sink assembly 100.

As modern microprocessors have become faster and more powerful, they also generate more heat. The current thermal interface materials used in the TIM1 layer 108 and the TIM2 layer 104 have thermal conductivities that may not be sufficiently large to conduct enough heat away from the microprocessor die 110 and to the heat sink 102.

### BRIEF DESCRIPTION OF THE DRAWINGS

The various embodiments of the invention are illustrated by way of example and not by way of limitation in the figures of the accompanying drawings, in which like references indicate similar elements and in which:

FIG. 1 is a side view of a microprocessor and heat sink assembly that illustrates how layers of thermal interface materials are used to conduct heat away from the microprocessor die to the heat sink.

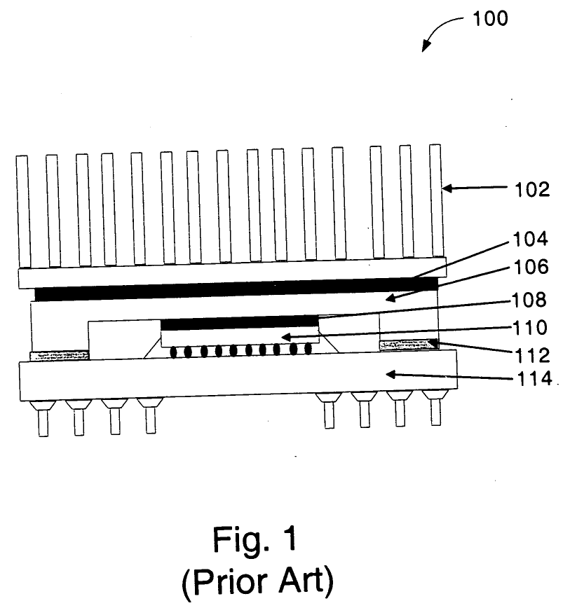

FIG. 2 is a side view of an improved microprocessor and heat sink assembly that includes layers of improved thermal interface material according to the present invention.

FIG. 3a is a flow chart that illustrates how the improved thermal interface material with aligned carbon nanotubes is made.

FIGS. 3b and 3c are side views of carbon nanotubes and alignment material both before (FIG. 3b) and after (FIG. 3c) alignment.

FIG. 4 is a flow chart that illustrates how an improved thermal interface material with aligned carbon nanotubes is made according to an embodiment of the present invention when clay is used as an alignment material.

FIG. 5 is a flow chart that illustrates in more detail how the clay material is prepared according to one embodiment.

FIG. 6 is a side view illustrating how the combined materials of FIG. 4 are subjected to shear forces and divided into pads according to one embodiment of the present invention.

FIG. 7 is a flow chart that illustrates how an improved thermal interface material with aligned carbon nanotubes is made according to an embodiment of the present invention when liquid crystal resin is used as an alignment material.

FIGS. 8a and 8b are side views that illustrate how the combined materials of FIG. 7 are layered on a film and then subjected to a field according to one embodiment of the present invention.

### DETAILED DESCRIPTION

References throughout this specification to “one embodiment” or “an embodiment” means that a feature, structure, material, or characteristic described in connection with the invention is included in at least one embodiment of the invention. Thus, the appearances of the phrases “in one embodiment” or “in an embodiment” in various places throughout this specification are not necessarily all referring to the same embodiment or invention. Furthermore, the features, structures, materials, or characteristics may be combined in any suitable manner in one or more embodiments.

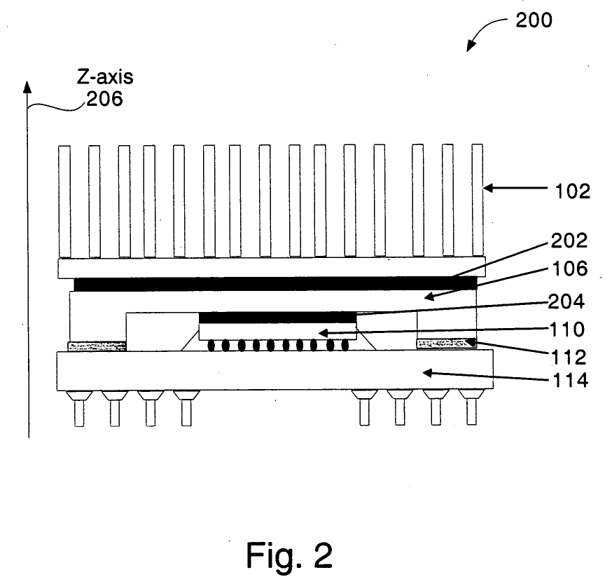

FIG. 2 is a side view of a microprocessor and heat sink assembly 200 that includes layers 202, 204 of improved thermal interface material according to one embodiment of the present invention. The thermal interface material includes carbon nanotubes aligned in the direction of heat transfer. This thermal interface material is therefore a nanocomposite thermal interface material (“NTIM”), and may have higher thermal conductivities than the thermal interface materials previously used. Through the use of the layers of thermal interface materials 202, 204, the microprocessor and heat sink assembly 200 of FIG. 2 may better remove heat from the microprocessor die 110.

The microprocessor and heat sink assembly 200 includes a substrate 114 to which a microprocessor die 110 is attached. There is a first thermal interface layer (“TIM1”) 204 between the microprocessor die 110 and an integrated heat sink (“IHS”) 106, which is connected to the substrate 114 by a sealant layer 112. The TIM1 layer 204 of an embodiment of the present invention includes carbon nanotubes combined with one or more other materials. The TIM1 layer 204 transfers heat away from the microprocessor 110 to the IHS 106. This heat may be transferred substantially in the direction of a z-axis 206 in one embodiment. To transfer the heat, the carbon nanotubes within the TIM1 layer 204 may be aligned to create heat-conducting paths in the direction of heat transfer, which in the illustrated embodiment is the direction of the z-axis 206. Aligning the carbon nanotubes to create heat-conducting paths in the direction of desired heat transfer improves the thermal conductivity of the layer of improved thermal interface material 204 along that direction 206. The thermal conductivity of the layer of improved thermal interface material 204 may be greater than about 100 W/mK, which provides improved heat transfer performance as compared to prior art thermal interface materials.

There is a second thermal interface layer (“TIM2”) 202 between the IHS 106 and a heat sink 102. In the embodiment illustrated in FIG. 2, the TIM2 layer 202 also includes carbon nanotubes combined with one or more other materials. The TIM2 layer 202 transfers heat away from the IHS 106 to the heat sink 102. This heat is transferred substantially in the direction of the z-axis 206 in one embodiment. To transfer this heat, the carbon nanotubes within the TIM2 layer 202 may be aligned to create heat-conducting paths in the direction of heat transfer, which in the illustrated embodiment is the direction of the z-axis 206. As with the TIM1 layer 204, aligning the carbon nanotubes in the TIM2 layer 202 to create heat-conducting paths in the direction of desired heat transfer may improve the thermal conductivity of the layer of improved thermal interface material 202 along that direction 206. As with the TIM1 layer 204, the thermal conductivity of the layer of improved thermal interface material 202 with aligned carbon nanotubes may be greater than about 100 W/mK, which provides improved heat transfer performance.

As shown in the above discussion of FIG. 2, the microprocessor die 110 may be a heat source. The first improved thermal interface material layer 204 may transfer the heat generated by the microprocessor die 110 substantially along the z-axis 206 to the IHS 106. The IHS 106 may be a heat receiver for receiving heat conducted away from the heat source, the microprocessor die 110. The heat then travels substantially along the z-axis 206 from the IHS 106 through the second improved thermal interface material layer 202 to the heat sink 102, which transfers the heat to the surrounding environment and away from the microprocessor and heat sink assembly 200. With the TIM2 layer 202, the IHS 106 may act as the heat source, and the heat sink 102 may act as the heat receiver. By aligning the carbon nanotubes in the layers of thermal interface material 202, 204 to create heat-conducting paths in the direction of heat transfer, which in this case is along the z-axis 206, improved thermal conductivity of greater than about 100 W/mK may be achieved.

While the microprocessor and heat sink assembly 200 of FIG. 2 has been described with both thermal interface layers 202, 204 as including aligned carbon nanotubes, this is not a requirement. It is possible to use the NTIM with carbon nanotubes aligned in the direction of heat transfer in only one of the thermal interface layers 202, 204 to improve the thermal conductivity of that layer. Applications other than a microprocessor and heat sink assembly 200 may also make use of a one or more of layers of thermal interface material. Such applications include in between a heat source, such as a die 110, and a heat receiver or heat remover, such as a heat sink 102, a vapor chamber, a heat pipe, or other heat receivers or removers. In such applications, the improved thermal interface material with aligned carbon nanotubes may be used as thermal interface material for improved heat transfer from a different type of heat source to a different type of heat receiver.

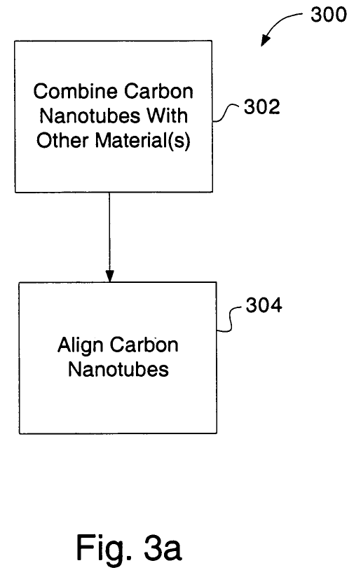

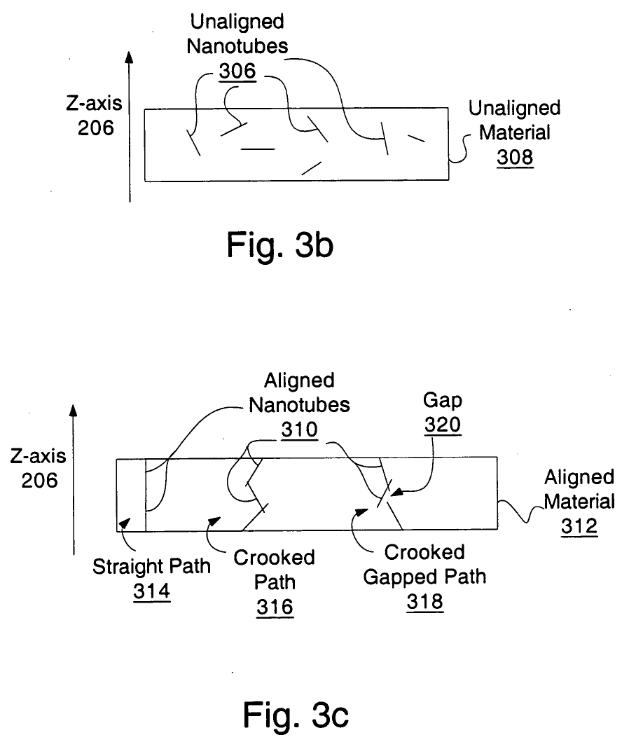

FIG. 3a is a flow chart 300 that illustrates how the improved thermal interface material with aligned carbon nanotubes is made in an embodiment. Carbon nanotubes are combined 302 with an alignment material to result in a combined material. The alignment material aids in aligning the carbon nanotubes within the improved thermal interface material in the direction in which heat will be transferred. The nanotubes and alignment material may also be combined 302 with one or more other materials to result in the combined material. These other materials may be a matrix or filler material, or other material. In one embodiment, the carbon nanotubes comprise greater than about 5 percent by weight of the combined material, although in some embodiments up to about 25 percent by weight of the carbon nanotubes is used, and still other embodiments larger amounts of carbon nanotubes are used. In general, a larger amount of carbon nanotubes results in a higher thermal conductivity. In some embodiments, the carbon nanotubes used have a mean length of greater than about 10 nm. In another embodiment, the carbon nanotubes used have a mean length of greater than about 100 nm. In general, longer mean lengths of carbon nanotubes results in better heat-conducting paths once the carbon nanotubes are aligned. In various embodiments, nanotubes with single or multiple walls are used. In some embodiments, the carbon nanotubes may be treated with surface modifications to improve wetting and/or dispersion into the NTIM material, or for other purposes.

The carbon nanotubes are then aligned 304. This may be done by aligning the alignment material. The alignment material has alignable structures. As the alignable structures within the alignment material are aligned, they cause the carbon nanotubes to become aligned as well. In various embodiments, different alignment materials are used, and the method of causing the alignment material to align the carbon nanotubes differs based upon which alignment material is used. Through use of an alignment material, alignment of the carbon nanotubes is eased, which allows creation of thermal interface material with aligned carbon nanotubes that is typically cheaper and more practical for more applications.

FIGS. 3b and 3c are side views of an embodiment of the combined material including the carbon nanotubes and alignment material both before (FIG. 3b) and after (FIG. 3c) alignment.

FIGS. 3b and 3c illustrate how aligning the carbon nanotubes may improve the thermal conductivity of the combined material. In the example illustrated in FIGS. 3b and 3c, it is desirable to conduct heat along the z-axis 206, from the bottom of the combined material to the top. Note that in other applications it may be desirable to conduct heat in different directions, so the carbon nanotubes may be aligned differently. In general, much of the heat conduction through the combined material occurs along the carbon nanotubes themselves. Paths created by aligned carbon nanotubes along which the heat can travel from one side of a material to another may provide increased thermal conductivity.

FIG. 3b illustrates unaligned combined material 308, with unaligned carbon nanotubes 306. The unaligned nanotubes 306 have substantially random orientations within the material 308. There are very few paths created by the unaligned carbon nanotubes 306 along which heat could travel along the z-axis 206 from the bottom of the material to the top. Thus, the thermal conductivity of the unaligned material 308 of FIG. 3b is relatively low.

FIG. 3c illustrates an embodiment of the aligned combined material 312, after the combined material is aligned 304 according to FIG. 3a. Carbon nanotubes conduct heat well. As mentioned above, the alignment material may include structures that cause the carbon nanotubes to become aligned as the alignment material is aligned. After alignment 304 of the combined material, the aligned carbon nanotubes 310 provide paths 314, 316, 318 along which heat can travel from the bottom of the aligned material 312 to the top. These paths 314, 316, 318 may greatly improve the thermal conductivity of the material.

One type of path that may be formed by aligning 304 the material is a straight path 314. In a straight path 314, the carbon nanotubes 310 have been substantially fully aligned along the z-axis 206, and one or more nanotubes make contact so as to make a substantially straight path 314 directly from the bottom of the aligned material 312 to the top of the aligned material 312. This straight path 314 provides a direct, unbroken, short path for heat to travel, which provides a very high thermal conductivity.

Another type of path formed by aligning 304 the material is a crooked path 316. The carbon nanotubes are not perfectly aligned along the z-axis 206, yet still make contact with each other so that a complete crooked path 316 is formed from the bottom of the aligned material 312 to the top of the aligned material 312. The crooked path 316 is not as short as the straight path 314, so the thermal conductivity may not be as high as along straight paths. However, heat flowing along this crooked path 316 may be conducted by the aligned carbon nanotubes 310, so the thermal conductivity of materials with such crooked paths is still quite high.

A third type of path formed by aligning 304 the material is a crooked path with one or more gaps 318. In such a gapped crooked path 318, heat may not travel all the way from the lower surface of the aligned material 312 to the upper surface of the aligned material 312 while being conducted by a carbon nanotube. However, the gaps 320 in such gapped crooked paths 318 in aligned material 312 may be smaller than the gaps present in unaligned material 308, so the thermal conductivity of materials with such gapped crooked paths 318 may still be higher than in the unaligned material 308. Gapped straight paths may also exist after alignment 304 of the material. Longer carbon nanotubes reduce the number of nanotubes needed to reach all the way across the aligned material, so longer nanotubes may reduce the number of gaps between nanotubes and increase the thermal conductivity of the aligned material 312.

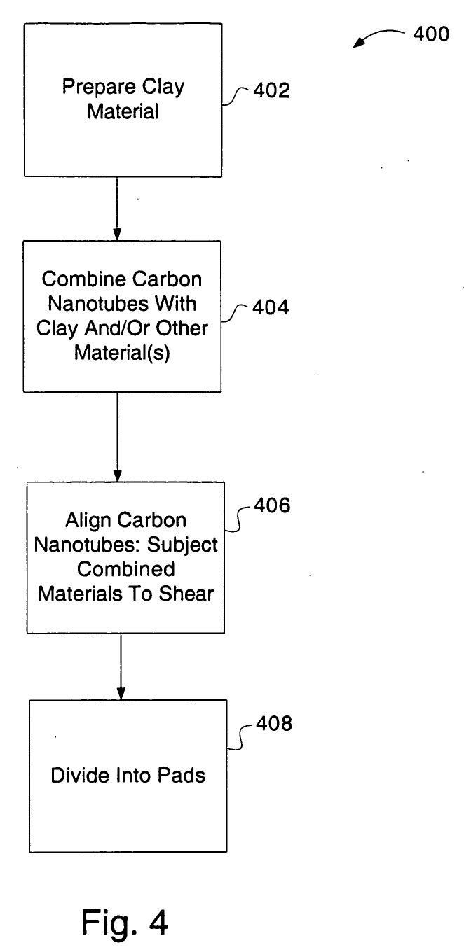

FIG. 4 is a flow chart 400 that illustrates how an thermal interface material with aligned carbon nanotubes may be made when clay is used as an alignment material according to an embodiment. The clay is prepared 402 for use in the improved thermal interface material. In some embodiments, the clays used may be an agglomeration of individual platelet particles that are closely stacked together like cards into domains called tactoids. In one embodiment, the individual platelet particles of the clay have a typical thickness of less than about 2 nm and a typical diameter in the range of about 10 nm to about 3000 nm. The clay may be chosen so that the diameter of the clay platelets is on the order of the length of the carbon nanotubes. The clays used in some embodiments of the present invention are swellable free flowing powders having a cation exchange capacity from about 0.3 to about 3.0 milliequivalents per gram of clay material (meq/g). Some embodiments use clays that are swellable free flowing powders having a cation exchange capacity from about 0.90 meq/g to about 1.5 meq/g.

In some embodiments, preparation 402 of the clay may be achieved by causing a swellable layered clay to react with one or more organic cations, which are ammonium compounds in some embodiments, to cause partial or complete cation exchanges. Many methods to accomplish this may be used.

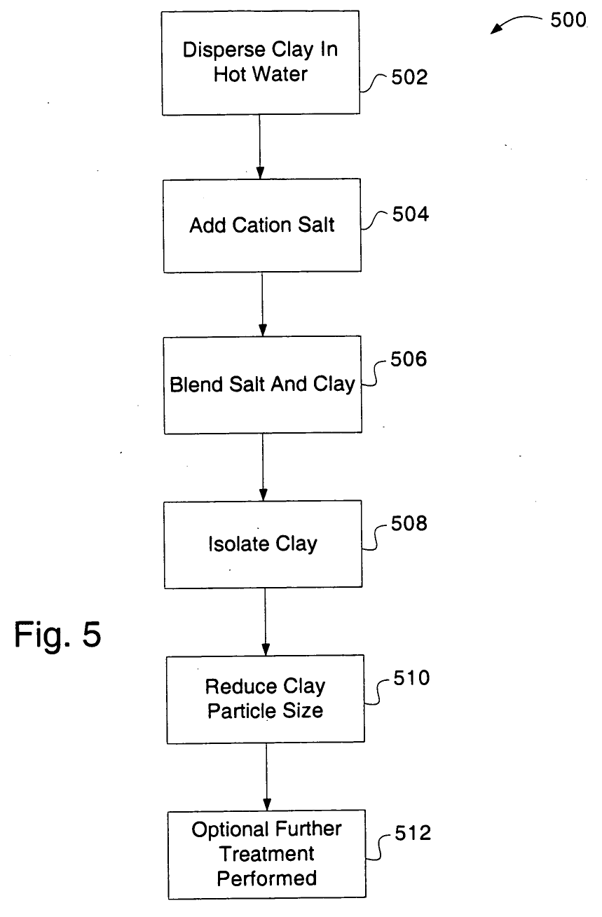

FIG. 5 is a flow chart 500 that illustrates in more detail how the clay material may be prepared 402 according to one embodiment. The clay is dispersed 502 into hot water with a temperature of about 50 degrees Celsius to about 80 degrees Celsius. An organic cation salt, alone or dissolved in water or alcohol, is then added 504 to the clay. The salt and clay are then blended 506 for a period of time sufficient for the organic cations to exchange most of the metal cations present in the galleries between the layers of the clay. This makes the clay more compatible with certain matrix materials, such as polymers, with which the clay will be combined. Other methods may be used to increase compatibility in place of cation exchange. The clay is then isolated 508, which can be accomplished by filtration, centrifugation, spray drying, and other methods or combinations of methods. The particle size of the clay is then reduced 510, typically to a mean size of less than 100 microns by methods such as milling, grinding, pulverizing, hammer milling, jet milling, and other methods or combinations of methods. Optionally, further treatments may be performed 512 on the clay. These treatments may include treatments that aid in exfoliation of the NTIM material into which the clay is combined, improving the strength of a polyamide clay interface of the NTIM material into which the clay is combined, and/or other treatments. One example of such a treatment is intercalation with water-soluble or water-insoluble polymers, organic reagents or monomers, silane compounds, metals or organometallics, and/or other appropriate materials or their combinations.

Returning to FIG. 4, the carbon nanotubes may then be combined 404 with the prepared clay. One or more other materials may also be combined 404 with the clay and the carbon nanotubes. The carbon nanotubes and other material(s) with which they are combined result in a combined material. In one embodiment of the present invention, the clay comprises less than about 25 percent by weight of the combined material. In another embodiment, the clay comprises less than about 5 percent by weight of the combined material, and in yet a third embodiment, the clay comprises less than about 2 percent by weight of the combined material. Enough clay may be used to provide enough platelets and tactoid structures to align the carbon nanotubes when the clay material is aligned. The clay used in the improved thermal interface material may be a natural clay, a synthetic clay, a modified phyllosilicate, or another clay or mixture of clays. Natural clays include smectite clays such as montmorillinite, saponite, hectorite, mica, vermiculite, bentonite, nontronite, beidelite, volkonskoite, magadite, kenyaite, and others. Synthetic clays include synthetic mica, synthetic saponite, synthetic hectorite, and others. Modified phyllosilicate clays include fluorinated montmorillonite, fluorinated mica, and others.

In some embodiments, one or more of a wide variety of matrix materials may be combined 404 with the carbon nanotubes and the prepared clay to form the combined material in some embodiments. For example, a matrix material may be chosen for its good wetting performance and/or its low interfacial resistance with carbon nanotubes. These matrix materials may include polymers such as silicones, epoxies, polyesters, and olefins, solders such as indium, tin, and their alloys, polymer-solder hybrids, or other matrix materials. Olefinic resins are useful because they have good wetting and low interfacial resistance with carbon nanotubes. Some examples of olefinic resins that may be used in some embodiments of the present invention include polyethylene, polypropylene, polystyrene, and paraffin wax. Other matrix materials may also be used to provide additional desired properties.

Thermally conductive or other filler materials may also be combined 404 with the carbon nanotubes and the prepared clay to form the combined material in some embodiments. Thermally conductive fillers may help improve the thermal conductivity of the combined, aligned material by improving the heat transfer along carbon nanotube paths that have gaps. The conductive fillers may improve the thermal conductivity of the gaps 320. Such fillers that are used in some embodiments include ceramics such as aluminum oxide, boron nitride, aluminum nitride, and others, metals such as aluminum, copper, silver, and others, solders such as indium and others, and other filler materials.

After combination 404, the clay may be dispersed in the combined materials so that most of the clay exists as individual platelet particles, small tactoids, and small aggregates of tactoids with height dimensions of less than about 20 nm in one embodiment, which means most of the clay exists as platelets or tactoids with less than about 15 stacked platelets in embodiments where the clay has a thickness of about 2 nm. In some embodiments, it is desirable to have higher numbers of individual platelet particles of the clay and fewer tactoids or aggregates of tactoids.

The combined materials may then be subjected 406 to shear forces. The shear forces align the structures within the clay, such as the platelets, tactoids, and aggregates of tactoids. As they become aligned, the platelets, tactoids, and aggregates of tactoids cause the carbon nanotubes to also be aligned so that the NTIM has improved thermal conductivity. Many methods can be used to subject 406 the combined materials to shear, including molding the combined materials, extruding the combined materials, and other methods. In some embodiments, the NTIM material that has been subjected 406 to shear is then divided 408 into pads of a selected thickness appropriate for the desired application. These pads can then be used in a wide variety of devices to transfer heat. For example the pads may be used as the TIM1 and TIM2 layers 202, 204 described above with respect to FIG. 2. A pad with aligned carbon nanotubes may be used as a TIM2 layer 202 because the NTIM pad allows the heat sink 102 to be removed and replaced, and allows a user to attach the heat sink 102 without special soldering knowledge or equipment. Thus, the NTIM material is suitable for use as a TIM2 layer 202 and has a thermal conductivity that is many times higher than the thermal conductivity of silicone grease materials currently used as a TIM2 layer 104.

In one embodiment of the present invention, 10 grams of silica clay were prepared 402. This clay was then combined 404 with 30 grams of single-walled carbon nanotubes and 60 grams of an alpha-olefinic resin matrix material by mixing the materials in a double planetary mixer for three hours at a temperature of 80 degrees Celsius. This combined material was then subjected 406 to shear force by extruding the combined material into a strand with a diameter of about 1 inch. This strand was then divided 408 in to pads with a thickness of about 0.25 millimeters. These pads were then tested and found to have a thermal conductivity of greater than about 100 W/mK.

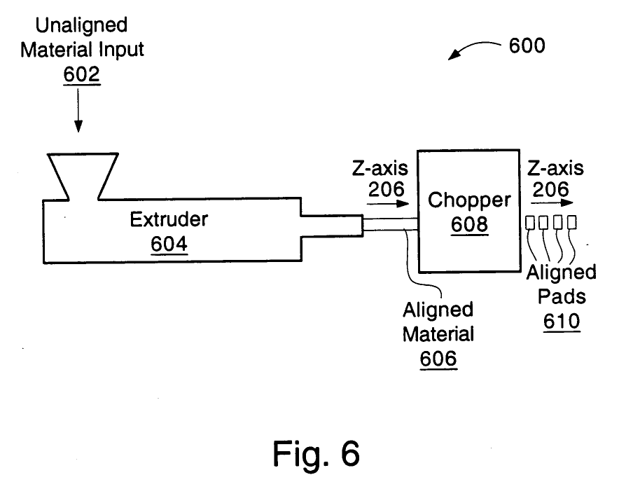

FIG. 6 is a side view illustrating how the combined materials of FIG. 4 are subjected 406 to shear forces and divided 408 into pads according to one embodiment of the present invention. The combined, unaligned material 602 is put into an extruder 604. The extruder 604 then extrudes a strand of aligned material 606. In other embodiments, uncombined materials may be put into the extruder 604, which both combines 602 and extrudes 604 the material. The strand is aligned because the extrusion process applies shear force to the material. This shear force aligns the alignable structures of the clay, which are platelets, tactoids, and aggregates of tactoids. Alignment of these alignable structures in turn causes alignment of the carbon nanotubes. As illustrated in FIG. 6, the alignment of the aligned material 606 is along the z-axis 206. To put the aligned material 606 in a more usable form, the extruded strand is input to a chopper 608, which cuts the strand into aligned pads 610 of a selected height suitable for use in a desired application. Note that the “height” is along the z-axis 206, so that the “height” in this case is measured from left to right in the illustration of FIG. 6. These pads can then be used, for example, as one or both of the TIM1 and/or TIM2 layers 204, 202 of FIG. 2, or in other applications.

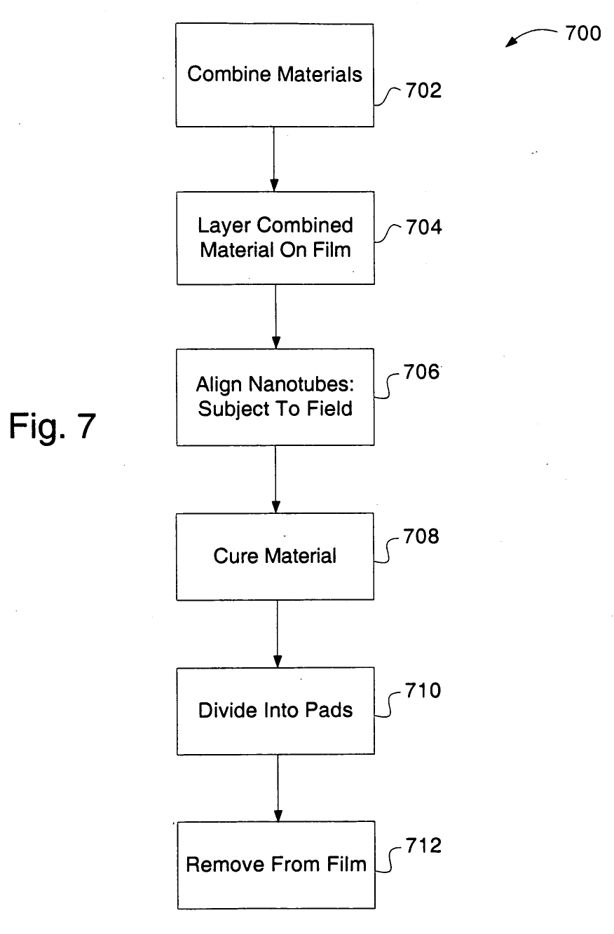

FIG. 7 is a flow chart 700 that illustrates how an improved thermal interface material with aligned carbon nanotubes may be made according to an embodiment of the present invention when liquid crystal resin is used as an alignment material. The carbon nanotubes are combined 702 with the liquid crystal resin. In one embodiment of the present invention, the liquid crystal resin comprises more than about 20 percent by weight of the combined material, and the combined material may consist of carbon nanotubes and liquid crystal resin. In other embodiments, the liquid crystal resin comprises about 15 percent by weight or more of the combined material. The liquid crystal resin includes alignable structures. Many different liquid crystal resins may be used, including rod-like liquid crystal resins, where the rods are the alignable structures. In some embodiments, liquid crystal resins with melting points less than about 200 degrees Celsius and/or are soluble in a solvent or diluent are used. Additionally, the liquid crystal resin may be functionalized with polymerizable units, such as epoxy, vinyl, hydroxyl, or other units to allow curing of the combined liquid crystal resin.

In some embodiments, one or more matrix materials may be combined 702 with the carbon nanotubes and the liquid crystal resin to result in the combined material. Such other matrix materials may include one or more of polymers such as silicones, epoxies, polyesters, and olefins, solders such as indium, tin, and their alloys, polymer-solder hybrids, or other matrix materials. Other matrix materials may also be used to provide additional desired properties.

Thermally conductive or other filler materials may be combined 702 with the carbon nanotubes and the liquid crystal resin to result in the combined material in some embodiments. Thermally conductive fillers may help improve the thermal conductivity of the combined, aligned material by improving the heat transfer along carbon nanotube paths that have gaps. The conductive fillers may improve the thermal conductivity of the gaps 320. Such fillers that are used in some embodiments include ceramics such as aluminum oxide, boron nitride, aluminum nitride, and others, metals such as aluminum, copper, silver, and others, solders such as indium and others, and other filler materials. Other processes may also be performed on the combined material.

The combined material is then layered 704 on a film, such as Mylar or another film or release liner. This film supports the combined material and makes handling and processing of the combined material easier. This layering 704 may be performed by casting the combined material on a film, printing the combined material on a film, or through other methods. A second film or release liner may be then layered on the combined material so that both sides of the material are covered in film. Combining 702 a solvent or diluent with the material may ease layering 704 the material on the film.

The combined material is then subjected 706 to a field. The field aligns the liquid crystal resin. In various embodiments, a magnetic field, an electric field, an electro-magnetic field, or other fields may be used to align the liquid crystal resin. The alignable structures, such as rod-like structures, in the liquid crystal resin in turn cause the carbon nanotubes to also become aligned to result in an NTIM with improved thermal conductivity. The orientation of the field is chosen so that the carbon nanotubes are aligned in a desired direction. The field also acts directly on the carbon nanotubes to help align the nanotubes. However, by including the alignment material of the liquid crystal resin, a much smaller field strength may be used to cause alignment of the carbon nanotubes than if an attempt was made to align the carbon nanotubes directly by the field without the alignment material. Combining 702 a solvent or diluent with the material may ease alignment of the material. Note that shear forces, such as those applied by extrusion and described above with respect to the embodiment where clay is the alignment material, may also be used to align the combined material where liquid crystal resin is the alignment material in place of or in addition to the field.

Optionally, the combined and aligned material may be cured 708. In some embodiments, the curing 708 occurs after aligning the carbon nanotubes, while in other embodiments, the curing 708 occurs during the alignment process, while the combined material is subjected 706 to the magnetic field. Curing the material may keep the carbon nanotubes aligned during later use.

The NTIM material is then divided 710 into pads for use. Typically, the film(s) is removed at the time the pad is applied as a thermal interface material, such as when a TIM2 layer 202 is applied to an IHS 106 in the example shown in FIG. 2, although it may also be removed at a different time. The pads can then be used in a wide variety of devices to transfer heat. For example the pads may be used as the TIM1 and TIM2 layers 202, 204 described above with respect to FIG. 2. A pad with aligned carbon nanotubes may be used as a TIM2 layer 202 because the NTIM pad allows the heat sink 102 to be removed and replaced. Thus, the NTIM material is suitable for use as a TIM2 layer 202 and has a thermal conductivity that is many times higher than the thermal conductivity of silicone grease materials currently used as a TIM2 layer 104.

In one embodiment of the present invention, 30 grams of alpha-olefinic resin with a softening point of 59 degrees Celsius, 30 grams of single-walled carbon nanotubes, 40 grams of 2,2′-dimethylstilbene (Tm =83 degrees Celsius), and 100 grams of toluene were combined 702 by adding them to a planetary mixer heated to about 80 degrees Celsius and mixed at 50 rpm for about one hour. The mixture was then passed twice through a 3-roll mill at about 80 degrees Celsius. The combined materials were then layered 704 onto a 40 micron thick Mylar film through casting. The film with the combined material was then subjected 706 to a magnetic field of about 0.3 Tesla for about thirty minutes to provide a desired alignment direction of the carbon nanotubes. The film with the combined material was then cured 708 by drying it at about 100 degrees Celsius, while still subjected 706 to the magnetic field. The film was divided 710 into pads. The film was removed 712 from the pads, which were then tested and found to have a thermal conductivity of about 100 W/mK.

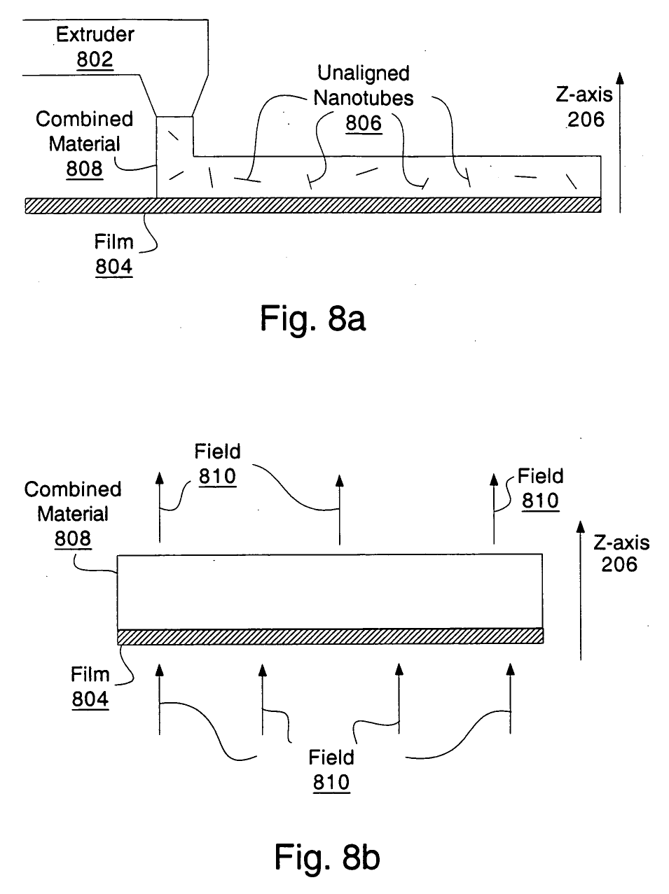

FIGS. 8a and 8b are side views that illustrate how the combined materials of FIG. 7 may be layered 704 on a film and then subjected 706 to a field according to one embodiment of the present invention. As illustrated by FIG. 8a, the combined, unaligned material 808 is layered 704 onto a film 804 by an extruder 802. The thickness of the combined material 808 can be selected to be appropriate for the application to which the aligned material will be put. In this example, the z-axis 206, along which the carbon nanotubes will be aligned, is substantially perpendicular to the plane of the film 804. The combined material 808 on the film 804 is then subjected 706 to a field 810, as shown in FIG. 8b. This field 810 aligns the liquid crystal resin in the combined material 808, which in turn causes the carbon nanotubes to become aligned.

The foregoing description of the embodiments of the invention has been presented for the purposes of illustration and description. It is not intended to be exhaustive or to limit the invention to the precise forms disclosed. Persons skilled in the relevant art can appreciate that many modifications and variations are possible in light of the above teaching. Persons skilled in the art will recognize various equivalent combinations, positions, and substitutions for various components shown in the Figures. It is therefore intended that the scope of the invention be limited not by this detailed description, but rather by the claims appended hereto.

1. A method, comprising:
combining at least carbon nanotubes and an alignment material to result in a combined material; and
causing the alignment material to align the carbon nanotubes.

2. The method of claim 1, wherein causing the alignment material to align the carbon nanotubes comprises applying a shear force to the combined material.

3. The method of claim 1, wherein causing the alignment material to align the carbon nanotubes comprises applying a field to the combined material.

4. The method of claim 3, wherein the field comprises at least one of an electric field, a magnetic field, or an electromagnetic field.

5. The method of claim 1, wherein the resulting combined material contains greater than five percent by weight carbon nanotubes.

6. The method of claim 1, further comprising combining a matrix material with the carbon nanotubes and alignment material to result in the combined material.

7. The method of claim 6, wherein the matrix material comprises at least one of silicone polymer, epoxy polymer, olefin polymer, indium solder, or tin solder.

8. The method of claim 1, further comprising combining a filler material with the carbon nanotubes and alignment material to result in the combined material.

9. The method of claim 8, wherein the filler material is a thermally conductive material comprising at least one of aluminum oxide, boron nitride, aluminum nitride, aluminum, copper, silver, or indium solder.

10. The method of claim 1, wherein the alignment material comprises a clay material.

11. The method of claim 10, further comprising preparing the clay material, wherein preparing the clay material comprises:
dispersing the clay material in hot water having a temperature ranging from about 50 degrees Celsius to about 80 degrees Celsius;
adding cation salt to the clay dispersed in hot water;
blending the cation salt and clay;
isolating the clay; and
reducing a clay particle size to a mean size of less than about 100 microns.

12. The method of claim 11, further comprising:
combining an alpha-olefinic resin matrix material with the carbon nanotubes and the prepared clay to result in the combined material, the combined material having about thirty percent by weight carbon nanotubes, about 10 percent by weight prepared clay, and about sixty percent by weight alpha-olefinic resin matrix material;
wherein causing the prepared clay alignment material to align the carbon nanotubes comprises extruding the combined material; and
dividing the extruded combined material into pads of a selected size.

13. The method of claim 10, wherein the clay material comprises a swellable free flowing powder having a cation exchange capacity from about 0.3 to about 3.0 milliequivalents per gram of clay material.

14. The method of claim 10, wherein the clay material comprises platelet particles with a mean thickness of less than about two nanometers and a mean diameter from about 10 nanometers to about 3000 nanometers.

15. The method of claim 1, wherein the alignment material comprises a liquid crystal resin material.

16. The method of claim 15, further comprising:
layering the combined material onto a film; and
curing the combined material after causing the alignment material to align the carbon nanotubes.

17. The method of claim 16, wherein: combining at least carbon nanotubes and an alignment material to result in a combined material comprises combining alpha-olefinic resin, carbon nanotubes, dimethylstilbene, and toluene, the combined material having about 15 percent by weight alpha-olefinic resin, about percent by weight carbon nanotubes, about 20 percent by weight dimethylstilbene, and about 50 percent by weight toluene; and causing the alignment material to align the carbon nanotubes comprises applying a magnetic field of about 0.3 Tesla to the layered combined material.

18-36. (canceled)
